(19) United States
(12) Patent Application Publication
(10) Pub. No.: US 2004/0192441 A1
(43) Pub. Date: Sep. 30, 2004

(54) Gaming machine

(76) Inventor: Nobuyuki Nonaka, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/697,947

(22) Filed: Oct. 31, 2003

(30) Foreign Application Priority Data
Mar. 28, 2003 (JP) 2003-092521

(51) Int. Cl. A63F 13/00

(52) U.S. Cl. 463/31

(57) ABSTRACT

A display device provided in a gaming machine such as a slot machine or a pachinko machine, wherein pixel units a and b are formed by arranging each one of a plurality of kinds of pixel electrodes R, G, and B that displays a predetermined color, one pixel is constituted by a pair of adjacent pixel units a and b, information signals for one pixel are supplied in the same timing to respective pixel electrodes (Ra, Rb), (Ga, Gb), and (Ba, Bb) for the same color included in each of the pair of pixel units a and b.

### FIELD OF THE TECHNOLOGY

This invention relates to a display device which is provided in a gaming machine such as a slot machine or a pachinko machine.

### DESCRIPTION OF RELATED ART

In recent years, in the market of gaming machines such as slot machines and pachinko machines, images are mentioned as one of important elements which constitute game property. Conventionally, in an image of a gaming machine, it has become a main stream to mount a liquid crystal monitor or a dot display device whose size is seven inches or less. According to a gaming machine provided with such a display device, it becomes possible by displaying an image according to the progress of a game in the gaming machine to display stages of progress of the game clearly, to make a player's expectations arouse, or to direct a winning status effectively (for example, see patent document No. 1).

In the above-mentioned display device and the gaming machine provided with the display device, while it is possible to expect high stage effects as the display screen has a large area, it can be said that an image displayed on the display device with finer pixels has a larger amount of information which can be displayed, as well as is more beautiful.

However, in a liquid crystal monitor, there is a problem that, although a pixel also becomes large as an area of the liquid crystal monitor rises, an image displayed becomes coarse as the pixel becomes large, and the resolution of the image is lowered. Hence, finer pixels are desired.

For example, refer to Japanese Patent Laid-Open No. 2001-340518.

### SUMMARY OF THE INVENTION

Nevertheless, as mention above, there is a problem that image data displayed increases when an area of a liquid crystal display monitor is enlarged and pixels are made finer. As a result, it comes to cause the delay of processing speed, the increase of volume of storage capacity, and the increase of manufacturing cost of the image data.

Then, this invention is made in view of the above problems, and provides a display device and a gaming machine which can make pixels of the display device fine and can achieve improvement in image quality without increasing image data in the display device, with which the gaming machine such as a slot machine or a pachinko machine is equipped.

In order to solve the above-mentioned problems, this invention is a display device provided in a gaming machine such as a slot machine or a pachinko machine, wherein a pixel unit is formed by arranging each one of a plurality of kinds of pixel electrodes that display predetermined colors respectively, and one pixel is constituted by a pair of adjacent pixel units. Moreover, an information signal for one pixel is supplied in the same timing to the pixel electrodes for the same color included in a pair of pixel units, respectively.

According to this invention as described above, it becomes possible to display one pixel by a pair of pixel electrodes since the information signals for one pixel are supplied to pixel electrodes with the same color included in an adjacent pixel unit respectively. Consequently, according to this invention, by displaying one pixel of existing image data by a pair of pixel electrodes, it becomes possible to make a distance between pixel electrodes with the same color (pitch between pixel units) about one half of the conventional one without increasing a data amount of the existing image data. Hence, finer pixels can be attained.

In addition, in a display device which is provided in a gaming machine such as a slot machine or a pachinko machine, by a pitch P between pixel units and a distance d to a player in a normal game posture from the display device concerned satisfying a relationship of P<tan(π/180/35)×d, pixel lines can be made hardly conspicuous. According to this invention, it is possible to attain finer pixels by adopting the above-mentioned constitution and to easily achieve the pitch P between pixel units satisfying the above-mentioned relationship.

In the above-mentioned invention, it is preferable that pixel electrodes are arranged in matrix on an xy plane, and that pixel electrodes for the same color are arranged in a y direction and the same pattern is continuously arranged in an x direction to form a stripe. In this case, since pixel electrodes of the same color are lined in the y direction, it is possible to reduce the spreading of an image at the time of displaying a slant line in comparison with the pixel electrodes arranged in other forms, such as a delta arrangement, a mosaic arrangement, or the like. Hence, it becomes possible to improve the image quality.

In addition, this invention may include a gaming machine, such as a slot machine or a pachinko machine. The game machine comprises a display unit that is constituted by a plurality of kinds of pixel electrodes that display predetermined colors respectively and are arranged in matrix, wherein a pixel unit is formed by arranging each kind of pixel electrodes, one pixel is constituted by a pair of adjacent pixel units, and an information signal for the pixel is supplied in the same timing to pixel electrodes for the same color that are contained in the pair of pixel units respectively.

According to this invention as described above, in the display unit provided in the gaming, machine, by displaying data for one pixel of existing image data with a pair of pixel electrodes, it becomes possible to make the pitch between pixel units about one half of the conventional one without increasing a data amount of the existing image data. Hence, it becomes possible to achieve finer pixels, and consequently, it becomes possible to display effectively the image according to the progress of the game in the gaming machine.

In the above-mentioned invention, it is preferable that pixel electrodes are arranged in matrix on an xy plane, and that pixel electrodes for the same color are arranged in a y direction and the same pattern is continuously arranged in an x direction to form a stripe. In this case, since pixel electrodes of the same color are lined in the y direction, it is possible to reduce the spreading of an image at the time of displaying a slant line in comparison with the pixel electrodes arranged in other forms. Hence, it becomes possible to improve the image quality.

In the above-mentioned invention, preferably, the display unit is a highly transmissive liquid crystal display provided on a game board. In this case, it becomes possible to make the above-mentioned fine image displayed on the game board, such as a reel unit of a slot machine, or a game board of a pachinko machine, with being overlapped. Hence, it is possible to attain improvement in power of expression more effectively.

### BRIEF DESCRIPTION OF THE DRAWINGS

FIG. 1 is an explanatory diagram showing the relationship between the assumed value and the value of pitch P;

FIG. 2 is an explanatory diagram schematically showing a display screen of a display device according to a first embodiment;

FIG. 3 is a structural diagram showing the internal configuration of the display device according to the first embodiment;

FIG. 4 is a timing chart showing the application timing of information signal voltages in the display device according to the first embodiment;

FIG. 5 is a schematic diagram showing a modified example of an arrangement form of pixel units according to the first embodiment;

FIG. 6 is a perspective view showing an appearance of a slot machine according to the first embodiment;

FIG. 7 is a block diagram showing the configuration of a control unit provided inside the slot machine according to the first embodiment;

FIG. 8 is a structural diagram showing the configuration of a display device according to a second embodiment; and

FIG. 9 is a graphical representation where the vertical axis is set as the sensitivity of a player to pixels and the horizontal axis logarithmically shows the number of pixel lines per one degree of the player's viewing angle (lines/deg) in a third embodiment.

### DETAILED DESCRIPTION OF THE INVENTION

Hereafter, a display device and a slot machine gaming machine according to an embodiment of this invention will be explained in detail with referring to drawings.

[First Embodiment]

(Configuration of Display Device)

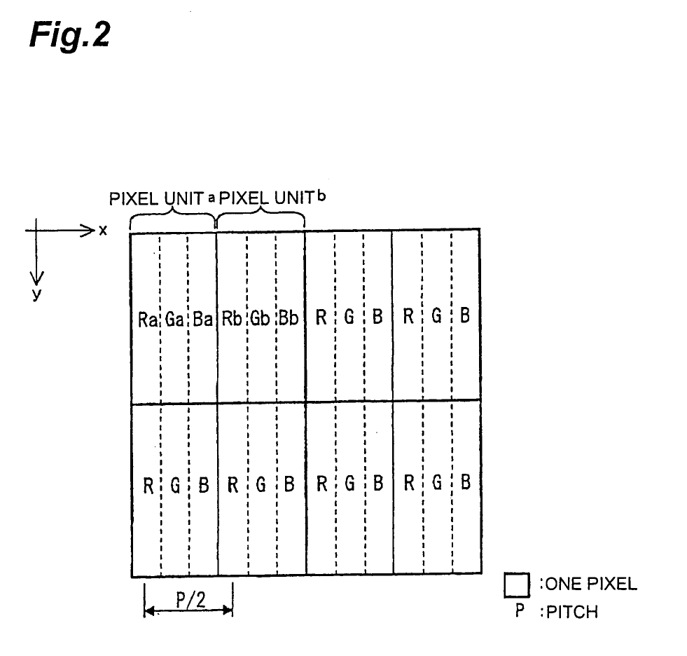

FIG. 2 is an explanatory diagram schematically showing a display screen of a display device according to a first embodiment. Note that, in this figure, only 4 pixels in 2×2 are shown in an enlarged manner.

As shown in this figure, in the display screen, a plurality of kinds of pixel electrodes R, G, and B (hereinafter, these are called Ra, Ga, Ba, Rb, Gb, and Bb appropriately) that display three colors of R (red), G (green), and B (blue) respectively are arranged in matrix on an xy plane, and pixel electrodes for the same color are arranged in the y direction and the same pattern is continuously arranged in the x direction to form a stripe.

Then, in this display screen, pixel units a and b are formed by arranging each kind of pixel electrodes R, G, and B, and one pixel is constituted by one pair of adjacent pixel units. Going in detail, a pixel unit a is formed by adjacently arranging the pixel electrodes Ra, Ga, and Ba, a pixel unit b is formed by adjacently arranging the pixel electrodes Rb, Gb, and Bb, and one pixel data is displayed by these adjacent pixel units a and b.

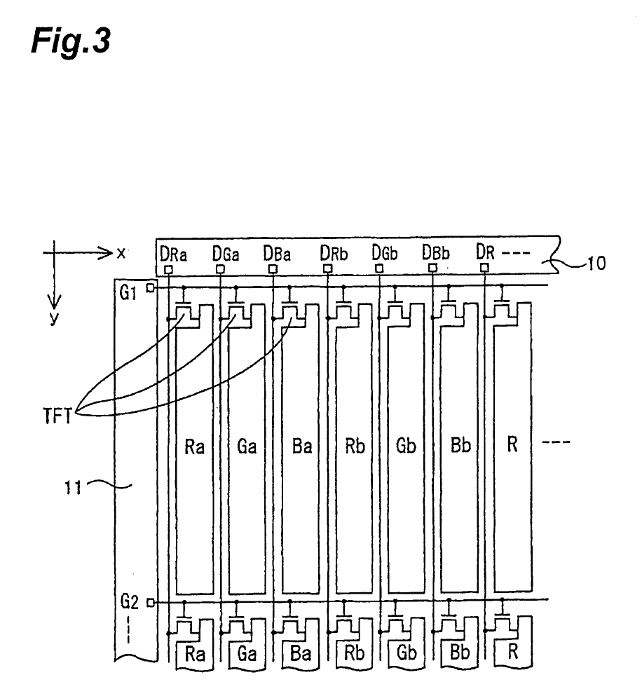

FIG. 3 shows a concrete configuration of this display screen. As shown in this figure, in the display device, gate lines G1, G2, . . . that are wired in a horizontal direction in this figure and are connected to the scanning signal driver 11, and information signal lines (source lines) DRa, DGa, . . . that are wired in a vertical direction in this figure and are connected to the information signal driver 10 that is drive control means are provided on a liquid crystal panel substrate so that they may be orthogonal in the condition of being insulated mutually. At each of their intersections, they are connected to each pixel electrode through a thin film transistor (TFT) which is an active element (switching element). That is, the gate lines G1, G2, . . . are connected to gate electrodes of the TFTs, the information signal lines DRa, DGa, . . . are connected to source electrodes of the TFTs, and the pixel electrodes are connected to drain electrodes of the TFTs.

In this configuration, the scanning signal driver 11 makes the scanning selection of the gate lines G1, G2, . . . by turns to supply gate voltages. In synchronization with this scanning selection of the gate lines, the information signal driver 10 supplies information signal voltages, corresponding to respective pixel data, to the information signal lines DRa, DGa, . . . , and applies them to respective pixel electrodes through the TFTs.

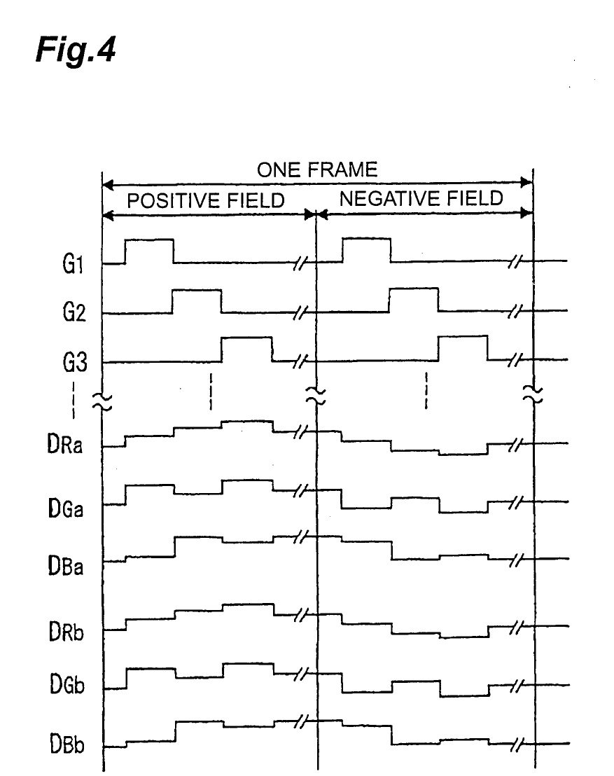

FIG. 4 shows the application timing of these information signal voltages. In addition, this figure shows voltage levels in a positive field and a negative field that are applied to the gate lines and information signal lines in the case that one frame is scanned by shuttling.

As shown in this figure, in this embodiment, the information signal voltages for one pixel are supplied in the same timing to pixel electrodes for the same color included in a pair of pixel units a and b. Namely, the scanning selection of the gate lines G1, G2, . . . is made by turns, the voltages are applied, and in synchronization with this timing of application to respective gate lines, information signal voltages at the same level and in the same timing are applied through the information signal lines DRa, DGa, . . . to pairs of pixel electrodes (Ra, Rb), (Ga, Gb), and (Ba, Bb).

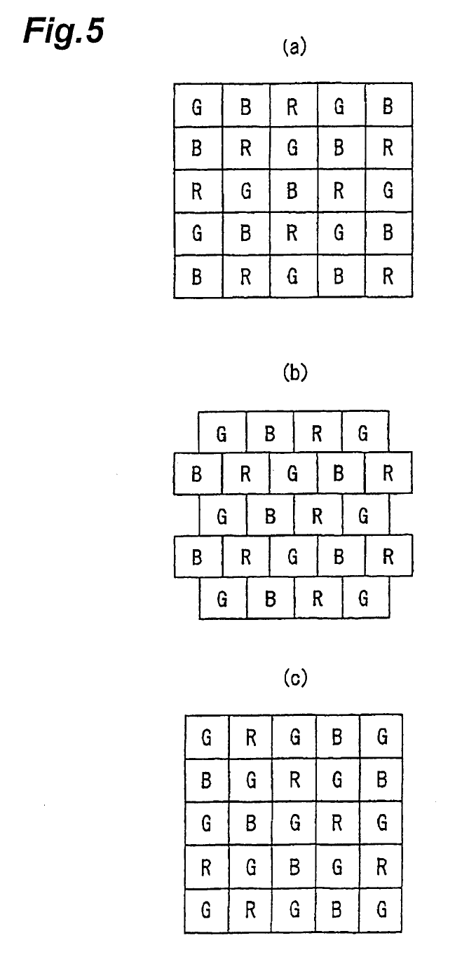

Note that, in this embodiment, although the case that pixels each formed by a pair of pixel units a and b are arranged in a stripe is explained as an example, this invention is not limited to this. As shown in FIG. 5, this invention is applicable also to a mosaic arrangement (FIG. 5(a)), a delta arrangement (FIG. 5(b)), or a 2G square arrangement (FIG. 5(c)). Also, in these cases, information signals for one pixel are supplied at the same level and in the same timing to respective pixel electrodes for the same color included in the pair of pixel units a and b.

(Configuration of Gaming Machine)

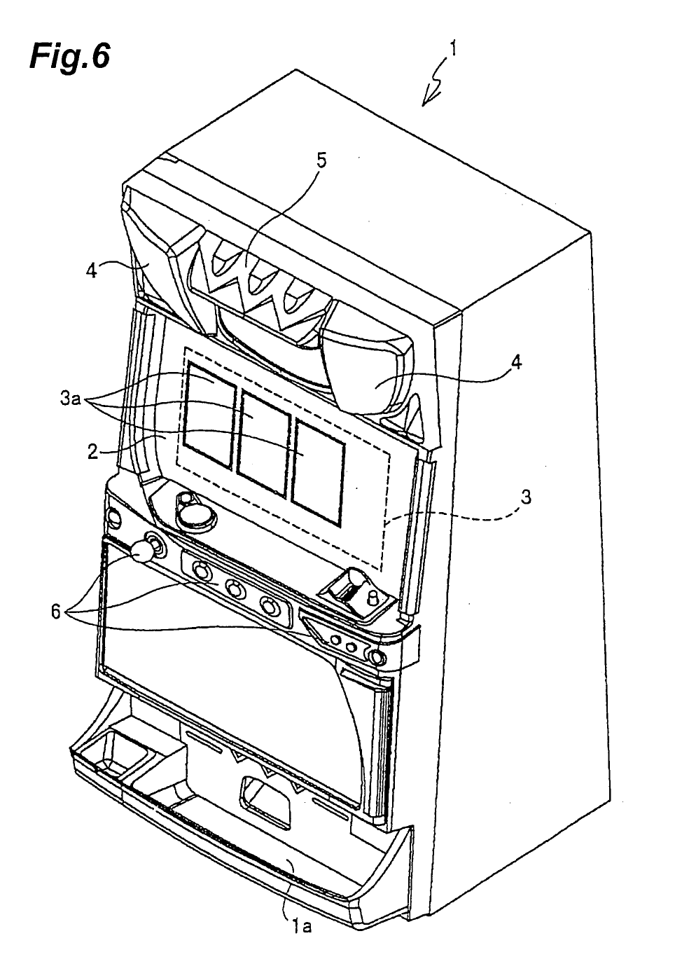

A gaming machine that is provided with the above-mentioned display will be explained. This embodiment will be explained by way of example where the display device is applied to a slot machine as a gaming machine. FIG. 6 is a perspective view and a front view that show the slot machine 1 according to this embodiment.

As shown in FIG. 6, a game board 2 is provided in the front of a main body of the slot machine 1, and on this game board 2, a transparent liquid crystal display 3 which is the display device mentioned above is provided in an area shown by dotted lines in the figure. In order to allow designs drawn on the outer periphery of reels provided in the main body of the slot machine 1 to be visible, reel display windows 3a are formed in this transparent liquid crystal display 3. In addition, various display units, such as lamps and segment indicators, are provided also in areas other than the transparent liquid crystal display 3 on the game board 2. Moreover, the slot machine 1 comprises a speaker 4, a lamp 5, an operation switch unit 6, and a medal receiving tray 1a in the front of the main body. The transparent liquid crystal display 3 is a highly transmissive liquid crystal display, and electrodes which apply voltages to liquid crystal are formed with electroconductive substances (for example, adaptive oxide of indium and tin, etc.) in transparent thin films.

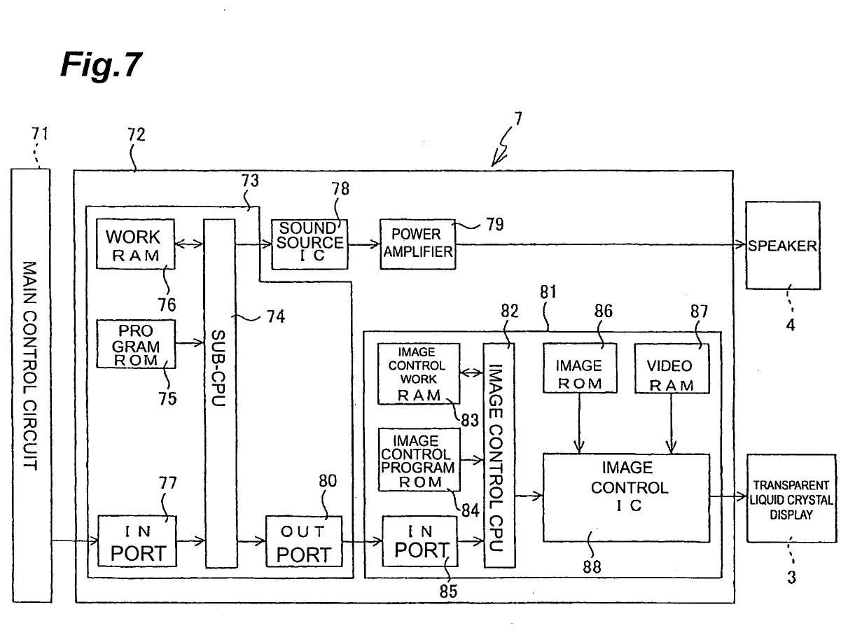

FIG. 7 is a block diagram showing the configuration of a control unit 7 provided inside the slot machine 1. As shown in this figure, the slot machine 1 comprises a main control circuit 71 for controlling game processing operation in the slot machine 1, peripheral devices (actuator etc.) electrically connected to the main control circuit 71, and a sub-control circuit 72 for controlling the transparent liquid crystal display 3 and speaker 4 on the basis of a control instruction transmitted from the main control circuit 71.

The main control circuit 71 mainly comprises a CPU arranged on a circuit board, and in addition to this, comprises a circuit performing random sampling at the time of performing the probability lottery processing of determining a winning. The CPU serves as internal winning combination determination means and winning judgment means to perform control operation according to a program set up beforehand, and also comprises ROM and RAM served as memory means. This memory means (ROM and RAM) stores the data used for the judgment of random sampling performed every start operation, and various control instructions (commands) for transmission to the sub-control circuit 72.

As the main actuators whose operation is controlled by control signals from the above-mentioned main control circuit 71, there are a lamp 5, various display units on the game board 2, a hopper (including a drive unit for payout) that contains coins and pays out the predetermined number of coins to the medal receiving tray 1a, which are shown in FIG. 6, and stepping motors for rotating reels. Each of these actuators is connected to an output unit of the above-mentioned main control circuit 71 through a drive circuit provided for each, and its operation is controlled in response to a control signal, such as a drive instruction outputted from the CPU.

Moreover, as main input signal generation means generating an input signal required for the main control circuit 71 to generate a control command, the operation switch unit 6 provided in the front of the slot machine 1, and an inserted coin sensor, and various sensors detecting operating statuses of reels are provided. The operation switch unit 6 detects the start of a game, and a stop operation of each reel, and the inserted coin sensor detects a coin inserted into a coin insertion slot. The various sensors for each reel supply signals for identifying respective reel positions to the main control circuit 71.

Then, in the main control circuit 71, in order to associate a rotational position of a reel with a design drawn on the outer periphery of the reel, a design table is stored in ROM. In this design table, each code number given one by one for every fixed rotation pitch of each reel is associated with each design code showing a kind of a design provided correspondingly for the code number. Furthermore, a winning design combination table is also stored in the ROM. On this winning design combination table, combinations of the designs showing winnings, coin payoff amounts of winnings, and winning judgment code showing those winnings are associated with each other. The above-described winning design combination table will be referred to when performing winning identification at the time of the stop of all reels.

The sub-control circuit 72 performs the display control of the transparent liquid crystal display 3, and the output control of sound from the speaker 4 on the basis of control instructions (commands) from the main control circuit 71. This sub-control circuit 72 is configured on a circuit board other than the circuit board where the main control circuit 71 is configured. This mainly comprises a microcomputer (hereafter, this is called “sub-microcomputer”) 73, and is constituted by an image control circuit 81 as display control means for the transparent liquid crystal display 3, a sound source IC 78 controlling the sound outputted by the speaker 4, and a power amplifier 79 as an amplifier.

The above-mentioned sub-microcomputer 73 includes a sub-CPU 74 performing control operation according to a control instruction transmitted from the main control circuit 71, a program ROM 75 as memory means, and a work RAM 76. The sub-control circuit 72 is configured so as to execute random sampling on an operating program in the sub-CPU 74. The program ROM 75 stores a control program executed by the sub-CPU 74. The work RAM 76 functions as temporary storage means when the sub-CPU 74 executes the above-mentioned control program.

The image control circuit 81 is constituted by an image control CPU 82, an image control work RAM 83, an image control program ROM 84, an image ROM 86, a video RAM 87, and an image control IC 88. The image control CPU 82 determines the contents of display in the transparent liquid crystal display 3 according to the image control program stored in the image control program ROM 84 on the basis of parameters set up by the sub-microcomputer 73. The image control program ROM 84 stores the image control program and various selection tables that relate to the display in the transparent liquid crystal display 3.

The image control work RAM 83 functions as temporary storage means when the image control CPU 82 executes the above-mentioned image control program. The image control IC 88 forms an image according to the contents of display determined by the image control CPU 82, and outputs it to the transparent liquid crystal display 3. The image ROM. 86 stores dot data for forming an image. The video RAM 87 functions as temporary storage means when the image control IC 88 forms an image.

Then, in the slot machine 1 having such a configuration, the operation switch unit 6 detects a player's operation. According to an operation signal from the operation switch unit 6, the control unit 7 drives each actuator to start a game. Subsequently, according to the stop operation of a player, each reel is stopped by turns. Then, when all reels stop, the main control circuit 71 refers to the winning design combination table in ROM to judge whether there is any winning design combination among combinations of designs currently displayed on the reel display window 3a. When there is a design combination which is a winning, the main control circuit 71 pays off the payoff amount of medals corresponding to the winning to the medal saucer 1a out of a hopper. Moreover, the main control circuit 71 outputs suitably to the sub-control circuit 72 a control instruction according to internal winning combination obtained as a result of the probability lottery processing, a player's stop operation, a kind of the winning, and the like.

The sub-control circuit 72 performs the display control of the transparent liquid crystal display 3, and the output control for sound from the speaker 4 on the basis of control instructions (commands) from the main control circuit 71. That is, the image control CPU 82 of the image control circuit 81 determines the contents of display in the transparent liquid crystal display 3 according to the image control program stored in the image control program ROM 84 on the basis of parameters set up by the sub-microcomputer 73. The image control IC 88 forms image data according to the contents of display determined by the image control CPU 82, and outputs it to the transparent liquid crystal display 3.

In the transparent liquid crystal display 3, according to the image data formed by the image control CPU 82, the scanning signal driver 11 makes scanning selection of the gate lines G1, G2, . . . by turns to supply gate voltages. In synchronization with this scanning selection of the gate lines, the information signal driver 10 applies information signal voltages for one pixel to each of pixel electrodes Ra, Ga, Ba, Rb, Gb, and Bb for the same color, which are included in each of a pair of pixel units, at the same level of the information signal voltages. Consequently, the image is displayed on the game board 2 so as to overlap with designs of each reel visually recognized through the reel display windows 3a.

(Action and Advantageous Effect)

According to the display device 3 and slot machine 1 in accordance with this embodiment explained above, the information signals for one pixel are supplied to each of the pixel electrodes Ra, Ga, Ba, Rb, Gb, and Bb for the same color included in the adjacent pixel units a and b respectively. Hence, it becomes possible to display one pixel by pairs of pixel electrodes (Ra, Rb), (Ga, Gb), and (Ba, Bb). In consequence, according to the display device 3 and slot machine 1 in accordance with this embodiment, by displaying one pixel of the existing image data by pairs of pixel electrodes (Ra, Rb), (Ga, Gb), and (Ba, Bb), as shown in FIG. 2, it becomes possible to make the pitch P between pixel units about one half of the conventional one without increasing the data amount of existing image data. Hence, finer pixels can be attained.

Moreover, according to the display device 3 and slot machine 1 in accordance with this embodiment, the pixel electrodes Ra, Ga, Ba, Rb, Gb, and Bb are arranged in a stripe on the xy plane. It is therefore possible to reduce the spreading of an image at the time of displaying a slant line in comparison with the case where pixel electrodes are arranged in other forms, such as a delta arrangement, a mosaic arrangement, or the like. Hence, it becomes possible to improve the image quality.

In addition, in the slot machine 1 according to this embodiment, a display device is made to be the highly transmissive transparent liquid crystal display 3 pasted to the game plane 2. Hence, it becomes possible to display images overlapping with designs of reels, being visible through the real display windows 3a and provided inside the main body, and with the game board 2. Hence, it is possible to attain improvement in power of expression more effectively.

[Second Embodiment]

Next, a second embodiment of this invention will be explained. In this embodiment, in the display device explained in the first embodiment, an output for one pixel from the information signal driver 10 which is drive control means, and respective pixel electrodes Ra, Ga, Ba, Rb, Gb, and Bb included in a pair of the above-mentioned pixel units a and b are connected in a one-to-many relationship.

Going in detail, in the display device in accordance with this embodiment, similarly to the first embodiment mentioned above, a plurality of kinds of pixel electrodes R, G, and B that display three colors of R (red), G (green), and B (blue) respectively are arranged in matrix on an xy plane, and pixel electrodes of the same color are arranged in the y direction and the same pattern is continuously arranged in the x direction to form a stripe (see FIG. 2). In this display screen, pixel units a and b are formed by arranging each kind of pixel electrodes R, G, and B, and one pixel is constituted by one pair of adjacent pixel units. Going in detail, the pixel unit a is formed by adjacently arranging the pixel electrodes Ra, Ga, and Ba, the pixel unit b is formed by adjacently arranging the pixel electrodes Rb, Gb, and Bb, and one pixel data is displayed by these adjacent pixel units a and b.

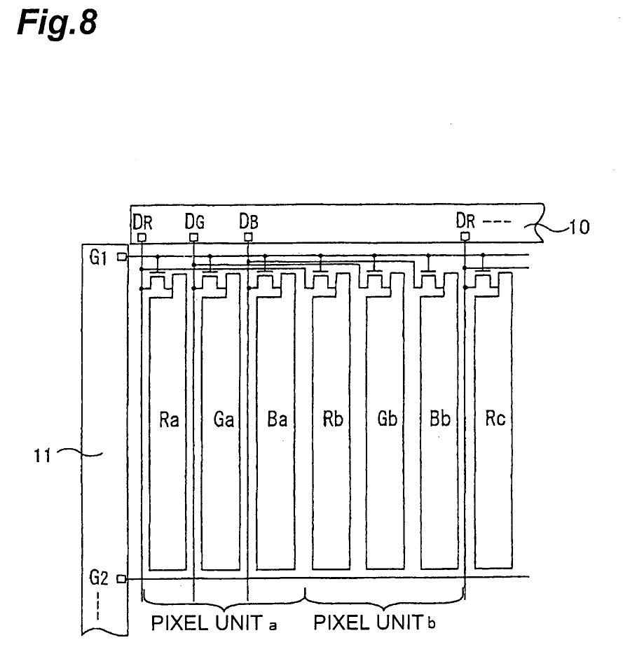

FIG. 8 shows a concrete configuration of this display screen. As shown in this figure, gate lines G1, G2, . . . that are wired in the horizontal direction in this figure and are connected to the scanning signal driver 11, and information signal lines (source lines) DR, DG, DB, that are wired in the vertical direction in this figure and are connected to the information signal driver 10 that is drive control means are provided on a liquid crystal panel substrate so that they may be orthogonal in the condition of being insulated mutually. At each of their intersections, they are connected to each pixel electrode through a thin film transistor (TFT) which is an active element (switching element).

Each of the information signal lines DR, DG, DB, . . . is branched on the way, and outputs for one pixel from the information signal driver 10, and pixel electrodes for the same color included in a pair of pixel units a and b respectively are connected in a one-to-two relationship. That is, the information signal line DR is connected to the pixel electrodes Ra and Rb, the information signal line DG is to the pixel electrodes Ga and Gb, and the information signal line DB is to the pixel electrodes Ba and Bb.

In this configuration, the scanning signal driver 11 makes the scanning selection of the gate lines G1, G2, . . . by turns to supply gate voltages. In synchronization with this scanning selection of the gate lines, the information signal driver 10 supplies information signal voltages, corresponding to respective pixel data, to the information signal lines DR, DG, DB, . . . and applies them to respective pixel electrodes through the TFTs. At this time, outputs for one pixel from the information signal driver 10, and pixel electrodes for the same color included in the pixel units a and b respectively are connected in the one-to-two relationship. Hence, the information signal voltages for one pixel are supplied in the same timing and at the same level to pixel electrodes for the same color included in each pixel unit.

According to the display device 3 and slot machine 1 in accordance with this embodiment explained above, the information signals for one pixel are supplied to each of the pixel electrodes Ra, Ga, Ba, Rb, Gb, and Bb for the same color included in the adjacent pixel units a and b respectively. Hence, it becomes possible to display one pixel by pairs of pixel electrodes (Ra, Rb), (Ga, Gb), and (Ba, Bb).

In particular, in this embodiment, by the information signal lines DR, DG, DB, . . . , outputs for one pixel from the information signal driver 10 and the pixel electrodes (Ra, Rb), (Ga, Gb), and (Ba, Bb) for the same color included in a pair of pixel units a and b respectively are connected in the one-to-many relationship. It therefore becomes possible to make the pitch P between pixel units about one half of the conventional one without requiring drastic improvement of drive control means such as an existing information signal driver, and increasing a data amount of the existing image data. Hence, finer pixels can be attained.

Moreover, according to the display device 3 and slot machine 1 in accordance with this embodiment, the pixel electrodes Ra, Ga, Ba, Rb, Gb, and Bb are arranged in a stripe on the xy plane. Therefore, it is possible to reduce the spreading of an image at the time of displaying a slant line in comparison with the case where pixel electrodes are arranged in another form, such as a delta arrangement, a mosaic arrangement, or the like. Hence, it becomes possible to improve the image quality.

[Third Embodiment]

Next, a third embodiment of this invention will be explained. In this embodiment, a pitch P (mm) between pixel units, which are explained in the above-mentioned first and second embodiments, and a distance d (mm) from the slot machine 1 concerned to a player in a normal game posture satisfy a following relationship:

P<tan(π/180/35)×d. (1)

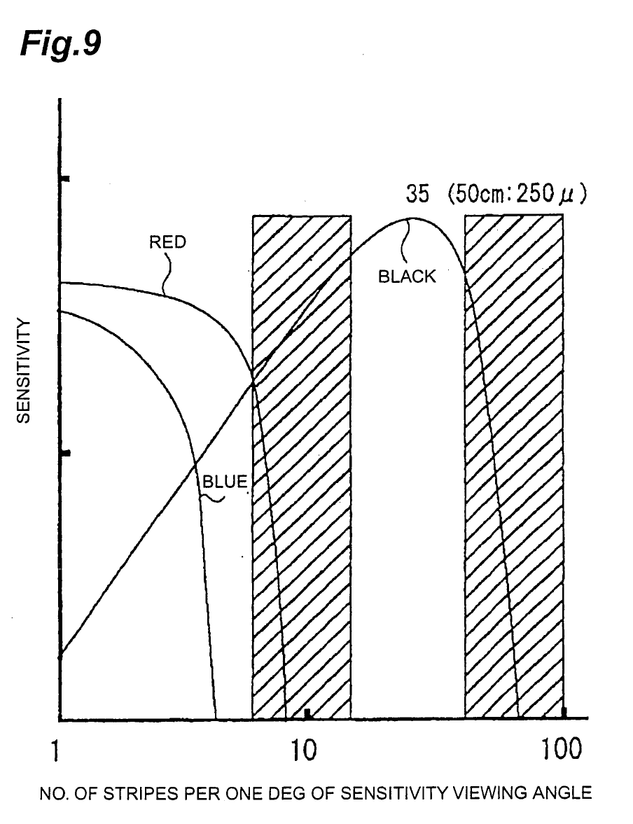

This will be explained in detail by using FIG. 9. FIG. 9 is a graphical representation where the vertical axis is set as the sensitivity of a player to pixels and the horizontal axis logarithmically shows the number of pixel lines per one degree of a player's viewing angle (lines/deg) (hereafter, this is called “number of stripes”). In addition, this number of stripes means the number of colored (black, blue, red) pixel lines at the time of displaying a white and an arbitrary color (for example, white and black, white and blue, white and red, or the like) in a stripe by turns for every pixel line.

As shown in this figure, when pixel lines are blue or red, sensitivity rapidly drops at the time of the number of stripes being about 5 to 8.5, which makes the pixel lines hardly conspicuous. When pixel lines are black, sensitivity rises until the number of stripes reaches 35 making the pixel lines conspicuous, and then drops rapidly after the number of stripes reaches a peak of 35.

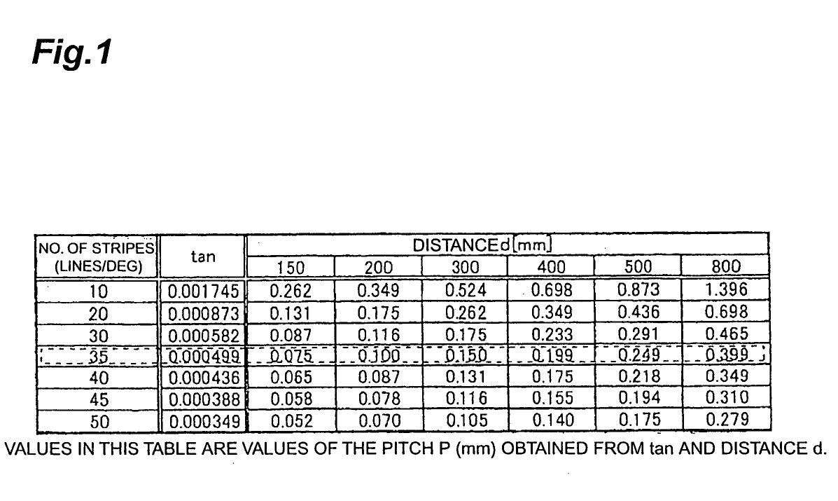

In this embodiment, with reflecting this property, in order that the number of stripes of pixel lines may exceed 35 (lines/deg), that is, in order that the pitch P between pixel units may become smaller than a predetermined value, the number of stripes of pixel lines is set up according to the relationship of the above-mentioned formula (1). Here, although the distance d from the display device to a player in a normal game posture changes according to the kind of a gaming machine, its assumed value is 300-400 mm in a pachinko machine, and 400-500 mm in a slot machine. The relationship between this assumed value and the value of the above-mentioned P is shown in FIG. 1.

[FIG. 1]

In addition, in FIG. 1, a range enclosed with dotted lines shows values of the pitch P corresponding to the above-mentioned number of stripes of pixel lines equal to 35. Values satisfying the above-mentioned formula (1) are in a range lower than a hatched portion in FIG. 1, i.e., a range where the number of stripes becomes 40 or more.

According to the display device and gaming machine according to this embodiment as described above, since a pitch between pixel units is set up in consideration of a player's normal game posture, it is possible to make pixel lines in the display device hardly conspicuous, and hence it is possible to attain a suitable image display.

In addition, the value of the pitch P between pixel units a and b is set up in this embodiment so that the above-mentioned formula (1) may be satisfied. Nevertheless, the value of the above-mentioned P may be set so that the pitch P (mm) and distance d (mm) may satisfy the following relationship:

P=tan(π/180/35)×d/2×(1+α) (2)

where the correction value α is ±0.1-0.2.

Going in detail of this, the distance d under normal use is 300-500 mm as mentioned above. Nevertheless, since a player's game posture changes every player or by a game status, it can be considered that a player approaches a gaming machine to about one half of the assumed distance d. Therefore, since pixels become conspicuous when a player approaches the gaming machine, the assumed distance d is set at one half in this modified example as shown in the above formula (2).

In addition, a pixel line becomes not conspicuous if the number of stripes is set to 35 or more. Nevertheless, even if the value of the pitch P is made small beyond necessity, it becomes impossible to visually recognize the difference with human eyes when the pitch P becomes below some extent. Hence, it is not reasonable in view of manufacturing cost etc. to make the number of stripes large beyond necessity. Furthermore, as shown in FIG. 9, pixel lines are not conspicuous so long as the number of stripes is equal to or larger than the peak value (about 5-8) for blue or red pixel lines even if it is 35 or less. In this modified example, therefore, by using the correction value α, the number of stripes is made within a hatched range in FIG. 9.

According to the display device and gaming machine in accordance with such a modified example, in addition to the actions and effects achieved by the first and second embodiments described above, it is possible not only to reduce the conspicuousness of pixel lines with taking a change of a player's game posture into consideration, but also to prevent an aperture ratio (a ratio of the gross area of one pixel to an area which a drive element effectively contributes to displaying in a display screen) of a liquid crystal drive element from being lowered due to unnecessarily fine pixels, thereby reducing a problem that a screen becomes dark and poorly visible.

As mentioned above, according to an image display device and a gaming machine in accordance with this invention, it is possible in a display device provided in the gaming machine to make pixels of the display device finer and to make pixel lines hardly conspicuous, without increasing image data. That is, by constituting one pixel by a pair of adjacent pixel units, and supplying information signals for one pixel in the same timing to pixel electrodes for the same color that are contained in the pair of pixel units respectively, it becomes possible to make the pitch between pixels finer by about one half with the conventional amount of image data.

Although only some exemplary embodiments of this invention have been described in detail above, those skilled in the art will readily appreciated that many modifications are possible in the exemplary embodiments without materially departing from the novel teachings and advantages of this invention. Accordingly, all such modifications are intended to be included within the scope of this invention.

This application is related to co-pending U.S. patent applications entitled “GAMING MACHINE” referred to as Attorney Docket No. SHO-0019, “GAMING MACHINE” referred to as Attorney Docket No. SHO-0020, “GAMING MACHINE” referred to as Attorney Docket No. SHO-0021, “GAMING MACHINE” referred to as Attorney Docket No, SHO-0022, “GAMING MACHINE” referred to as Attorney Docket No. SHO-0023, “GAMING MACHINE” referred to as Attorney Docket No. SHO-0024, “GAMING MACHINE” referred to as Attorney Docket No. SHO-0025, “GAMING MACHINE” referred to as Attorney Docket No. SHO-0026, “GAMING MACHINE” referred to as Attorney Docket No. SHO-0027, “GAMING MACHINE” referred to as Attorney Docket No. SHO-0028, “GAMING MACHINE” referred to as Attorney Docket No. SHO-0029, “GAMING MACHINE” referred to as Attorney Docket No. SHO-0030, “GAMING MACHINE” referred to as Attorney Docket No. SHO-0031, “GAMING MACHINE” referred to as Attorney Docket No. SHO-0032, “GAMING MACHINE” referred to as Attorney Docket No. SHO-0033, “GAMING MACHINE” referred to as Attorney Docket No. SHO-0034, “GAMING MACHINE” referred to as Attorney Docket No. SHO-0035, “GAMING MACHINE” referred to as Attorney Docket No. SHO-0036, “GAMING MACHINE” referred to as Attorney Docket No. SHO-0037, “GAMING MACHINE” referred to as Attorney Docket No. SHO-0038, “GAMING MACHINE” referred to as Attorney Docket No. SHO-0039, “GAMING MACHINE” referred to as Attorney Docket No. SHO-0040, “GAMING MACHINE” referred to as Attorney Docket No. SHO-0041, “GAMING MACHINE” referred to as Attorney Docket No. SHO-0042, “GAMING MACHINE” referred to as Attorney Docket No. SHO-0043, “GAMING MACHINE” referred to as Attorney Docket No. SHO-0044, “GAMING MACHINE” referred to as Attorney Docket No, SHO-0045, “GAMING MACHINE” referred to as Attorney Docket No. SHO-0046, “GAMING MACHINE” referred to as Attorney Docket No. SHO-0047, “GAMING MACHINE” referred to as Attorney Docket No. SHO-0048, “GAMING MACHINE” referred to as Attorney Docket No. SHO-0049, “GAMING MACHINE” referred to as Attorney Docket No. SHO-0050, “GAMING MACHINE” referred to as Attorney Docket No. SHO-0051, “GAMING MACHINE” referred to as Attorney Docket No. SHO-0052, “MOTOR STOP CONTROL DEVICE” referred to as Attorney Docket No. SHO-0053, “GAMING MACHINE” referred to as Attorney Docket No. SHO-0054, “GAMING MACHINE” referred to as Attorney Docket No. SHO-0055, “GAMING MACHINE” referred to as Attorney Docket No. SHO-0056 and “GAMING MACHINE” referred to as Attorney Docket No. SHO-0057, respectively, all the applications being filed on Oct. 31, 2003 herewith. The co-pending applications including specifications, drawings and claims are expressly incorporated herein by reference in their entirety.

What is claimed is:

1. An image display device provided in a gaming machine, wherein
a pixel unit is formed by arranging each one of a plurality of kinds of pixel electrodes that display predetermined colors respectively, and one pixel is constituted by a pair of adjacent pixel units, and
an information signal for the pixel is supplied in the same timing to the pixel electrodes for the same color included in the pair of pixel units, respectively.

2. The image display device according to claim 1, wherein the pixel electrodes are arranged in matrix on an xy plane, and the pixel electrodes of the same color are arranged in a y direction and the same pattern is continuously arranged in an x direction to form a stripe.

3. A gaming machine, such as a slot machine or a pachinko machine, comprising:
a display unit that is constituted by a plurality of kinds of pixel electrodes that display predetermined colors respectively and are arranged in matrix,
wherein a pixel unit is formed by arranging each kind of pixel electrodes, one pixel is constituted by a pair of adjacent pixel units, and an information signal for the pixel is supplied in the same timing to pixel electrodes for the same color that are contained in the pair of pixel units, respectively.

4. The gaming machine according to claim 3, wherein the pixel electrodes are arranged in matrix on an xy plane, and the pixel electrodes of the same color are arranged in a y direction and the same pattern is continuously arranged in an x direction to form a stripe.

5. The gaming machine according to claim 3, wherein the display unit is a highly transmissive liquid crystal display provided on a game board.
